(19) United States
(12) Patent Application Publication
(10) Pub. No.: US 2025/0217210 A1
(43) Pub. Date: Jul. 3, 2025

(54) GENERATION AND MANAGEMENT OF COMMUNICATION WORKFLOWS USING PROFILE STATE CONSISTENCY APPROACH

(71) Applicant: Twilio Inc., San Francisco, CA (US)

(72) Inventors: Fawad Halim, Addison, IL (US); Krishna Tushare Dharaiya, San Francisco, CA (US)

(21) Appl. No.: 18/400,934

(22) Filed: Dec. 29, 2023

(51) Int. Cl. G06F 9/54

(52) U.S. Cl. CPC G06F 9/542

(57) ABSTRACT

Various embodiments described herein support or provide operations including detecting an event associated with an entity; determining that the event is mapped to a journey that comprises a plurality of steps configured by the entity; placing the entity in a current step in the journey; evaluating one or more factors to determine that the entity is not simultaneously placed in another step of the journey; and using a state machine to process the event based on an operation associated with a step subsequent to the current step in the journey.

### TECHNICAL FIELD

Various embodiments described herein provide for systems, methods, techniques, instruction sequences, and devices that facilitate the generation and management of communication workflows using profile state consistency approach.

### BACKGROUND

Current systems face challenges when it comes to generating and managing communication workflows that automate communication based on user actions and/or scheduled events. For example, keeping track of users' states and/or steps throughout the communication workflows is challenging. If a user is mistakenly placed in multiple steps simultaneously within a single workflow, the user may receive redundant and/or irrelevant messages, negatively affecting user experience.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system in an artificial intelligence system, according to various embodiments of the present disclosure.

FIG. 2 is a block diagram illustrating an example data management system that facilitates the generation and management of communication workflows, according to various embodiments of the present disclosure.

FIG. 3 is a flowchart illustrating an example method for facilitating the generation and management of communication workflows using event filters, according to various embodiments of the present disclosure.

FIG. 4 is a flowchart illustrating an example method for facilitating the generation and management of communication workflows using event filters, according to various embodiments of the present disclosure.

FIG. 5 is a flowchart illustrating an example method for facilitating the generation and management of communication workflows using profile state consistency approach, according to various embodiments of the present disclosure.

FIG. 6 is a block diagram illustrating an example data system for facilitating the generation and management of communication workflows, according to various embodiments of the present disclosure.

FIG. 7 is a sequence diagram illustrating an example data flow for facilitating the generation and management of communication workflows using event filter, according to various embodiments of the present disclosure.

FIG. 8 is a block diagram illustrating a representative software architecture, which may be used in conjunction with various hardware architectures herein described, according to various embodiments of the present disclosure.

FIG. 9 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter can be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations, and details are set forth in order to provide a thorough understanding of the present subject matter. However, it will be apparent to one of ordinary skill in the art that embodiments of the subject matter described can be practiced without the specific details presented herein, or in various combinations, as described herein. Furthermore, well-known features can be omitted or simplified in order not to obscure the described embodiments. Various embodiments may be given throughout this description. These are merely descriptions of specific embodiments. The scope or meaning of the claims is not limited to the embodiments given.

Various embodiments include systems, methods, and non-transitory computer-readable media that facilitate generating and managing communication workflows using event filters. Specifically, communication workflows refer to sequences of interactions and/or communication designed to engage with users. A communication workflow can include one or more steps configured by a user via a user interface of a device. A journey can include one or more workflows. Each step of a communication workflow can be associated with one or more actions and one or more conditions that trigger the one or more actions. A communication workflow can be associated with metadata that is used to reference another step within the workflow, or reference one or more steps in another workflow. Various embodiments provide user-friendly interfaces to design and manage flows of interactions across various communication channels, such as SMS messages, voice calls, email, etc. Under this approach, users can automate interactions through predefined communication workflows to set up automated responses, reminders, and/or notifications based on user behavior and/or triggers. Further, various embodiments provide customized communication based on user actions and/or preferences to enhance the user experience, leading to higher conversion rates for various goals, including sales, user sign-ups, etc.

### Event Filter

In various embodiments, an event filter filters incoming messages based on definitions of communication workflows and relays the qualified messages (also referred to as events or qualified events) to the corresponding state machines for downstream processing. Specifically, a data management system detects one or more events. Each event can include (or be associated with) a state object that indicates a state of a user and/or a state of an action associated with a user. The data management system uses one or more event filters to map the one or more events to one or more communication workflows based on the content of the one or more events. A journey can include one or more communication workflows. The mapping of the one or more events includes determining that the content of the one or more events satisfies the definitions of the journeys. In various embodiments, the data management system identifies a state machine associated with a journey. A state machine can refer to a computational model that represents different states of complex systems and/or communication processes and the transitions between those states based on certain events or conditions. A state machine can change (or transition) from one state to another in response to inputs. State machines can help manage communication workflows and provide a structured way to design, implement, and manage complex workflows by defining the possible states, the conditions triggering state transitions, and the actions to be taken in each state. For example, a state machine can be used to model various states (e.g., initiating call, ringing, connected, on hold, ended) of a call when building a phone call application using the example data system 100 described herein. Each of these states can be associated with actions, triggers, and conditions that determine how the call progresses from one state to another. Such a progression determination can be made based on user input, time limits, or events triggered by the data system described herein.

In various embodiments, the data management system uses a state machine to process an event (e.g., a filtered event) based on the associated state object in accordance with one or more steps defined for a journey. Filtered events can be saved in a log of events (e.g., Kafka topic) with a predetermined retention period (e.g., 24 hours).

In various embodiments, a single event (e.g., a filtered event) can be mapped to a plurality of journeys. The data management system can use one or more state machines to process one or more steps defined for each of the plurality of journeys.

In various embodiments, each step in a journey can be associated with metadata that is used to reference another step within the journey. In various embodiments, a step in a journey can also be associated with metadata that is used to reference a step in another journey. A state machine can be used to model a plurality of states associated with a user, a system, a communication workflow, etc.

In various embodiments, a workflow can include one or more steps sequentially arranged in a logical order. A workflow can allow a user to trigger an operation associated with a step of the journey once an operation associated with a previous step of the journey has been triggered. In various embodiments, a journey (also referred to as a communication workflow) can be configured and managed by a user via a user interface of a device.

In various embodiments, an event can be a system-generated event or a user-triggered event. In various embodiments, the data management system determines a current step in a journey that matches a user-triggered event. The data management system identifies a subsequent step from the journey based on the current step, and uses a state machine to initiate an operation associated with the subsequent step based on the satisfaction of one or more conditions of the current step. The satisfaction of one or more conditions of the current step dictates how an entity progresses from the current step to the subsequent step. For example, a user-trigger event is detected and determined that the event is related to an action, such as a user abandoning a shopping cart. The data management system uses an event filter to map the event to a journey associated with the user. In accordance with the steps defined for the journey, the system determines the user's current step (e.g., checkout started) and one or more conditions to trigger a subsequent step. In this example, the user abandoning a shopping cart can be a condition to trigger a subsequent step (e.g., awaiting payments). Based on the determination, the data management system uses a state machine that handles the journey to initiate one or more actions associated with the subsequent step. An example of such an action can be transmitting one or more follow-up messages to the user with relevant product information.

In various embodiments, the data management system detects an event (e.g., a filtered event) associated with an entity (e.g., a user). Upon determining, based on the content of the event, that the event does not map to any definition of a journey associated with the entity, the data management system generates a state machine based on the event. The generated state machine can model each step in the journey associated with the entity and handle one or more journeys to be configured by the entity. The handling of a journey can include initiating an operation associated with each step based on the current state of the entity.

In various embodiments, in order to map an event to a journey based on the content of the event, the data management system can use a software library to match a plurality of rules against the content of the event. The plurality of rules can be user-defined rules. The software library allows users to build applications that match a number of rules against events at a high processing speed (e.g., several hundred thousand events per second). Both events and rules can be JavaScript Object Notation (JSON) objects, but rules can additionally be expressed through an inbuilt query language that describes custom matching patterns.

### Profile State Consistency

A profile's (e.g., user profile) trip through a journey shall clearly define where a user is in a journey. At no point should a “profile and epoch” pair be simultaneously in multiple places (e.g., steps) in a given journey, or in a user-defined part of a given journey. In other words, each user can have one journey state (per user-defined concurrency criteria, for example), and each journey state can have one epoch at a time (for a given concurrency key). Epoch can be represented by an epoch object created upon entering a journey, and maintained until a user is deemed to have exited from the journey.

In various embodiments, upon determining that an event is mapped to a journey, the data management places an entity (e.g., a user) in a current step in the journey based on a state object of the event (or a state object of the journey). The data management system evaluates one or more factors to determine that the entity is not simultaneously placed in another step of the journey. One or more factors can correspond to one or more of, without limitation, the evaluation of memberships, setting of evaluation windows, setting of priorities, existing entities, moving of profiles, and support analytics.

In various embodiments, in response to determining that the entity (e.g., user) is not simultaneously placed in another step of the journey, the data management system uses a state machine to process the event based on an operation associated with a step subsequent to the current step in the journey.

In various embodiments, the data management system updates a profile associated with a user based on the processing of the event.

In various embodiments, the data management system determines an event does not map to any journey associated with an entity (e.g., a user). Based on the determination, the data management system discards the event and/or passes the event to another system and/or component for processing.

In various embodiments, the data management system identifies one or more attributes (e.g., event properties) of an event (e.g., filtered event). Upon identifying a journey associated with the event, the data management system stores the one or more attributes of the event in the journey. Attributes of an event can include contextual data associated with the user profile, such as journey identifier, step identifier, timestamp data, etc.

Reference will now be made in detail to embodiments of the present disclosure, examples of which are illustrated in the appended drawings. The present disclosure may, however, be embodied in many different forms and should not be construed as being limited to the embodiments set forth herein.

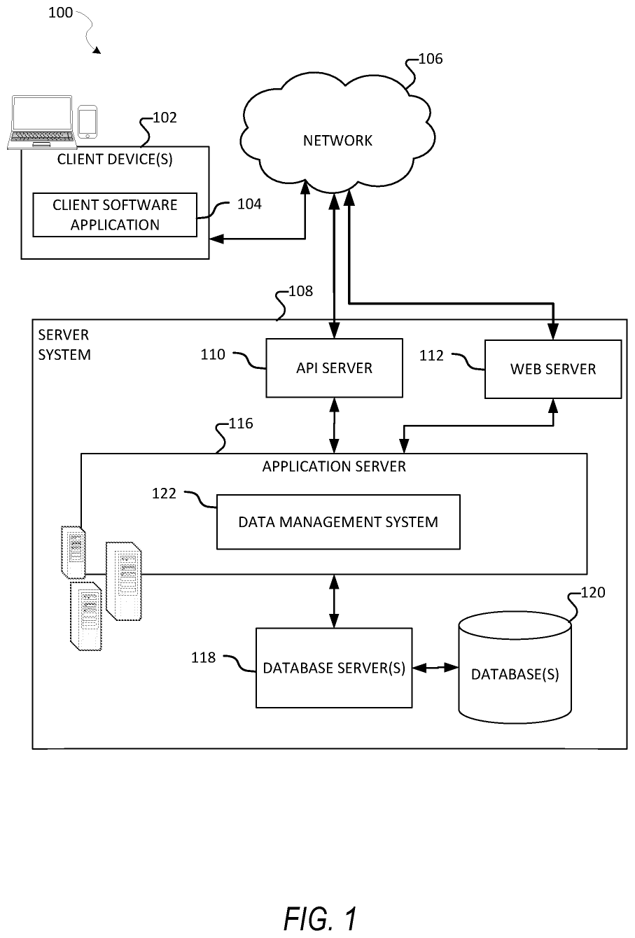

FIG. 1 is a block diagram showing an example data system 100 that includes a data management system (hereafter, the data management system 122, or system 122), according to various embodiments of the present disclosure. By including the data management system 122, the data system 100 can facilitate the generation and management of formatted content using machine learning technologies. As shown, the data system 100 includes one or more client devices 102, a server system 108, and a network 106 (e.g., including Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108.

It will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 to the system 122, and the system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the data management system 122 of the application server 116.

The application server 116 hosts a number of applications and subsystems, including the data management system 122, which supports various functions and services with respect to various embodiments described herein. The application server 116 is communicatively coupled to a database server 118, which facilitates access to database(s) 120 that stores data associated with the data management system 122.

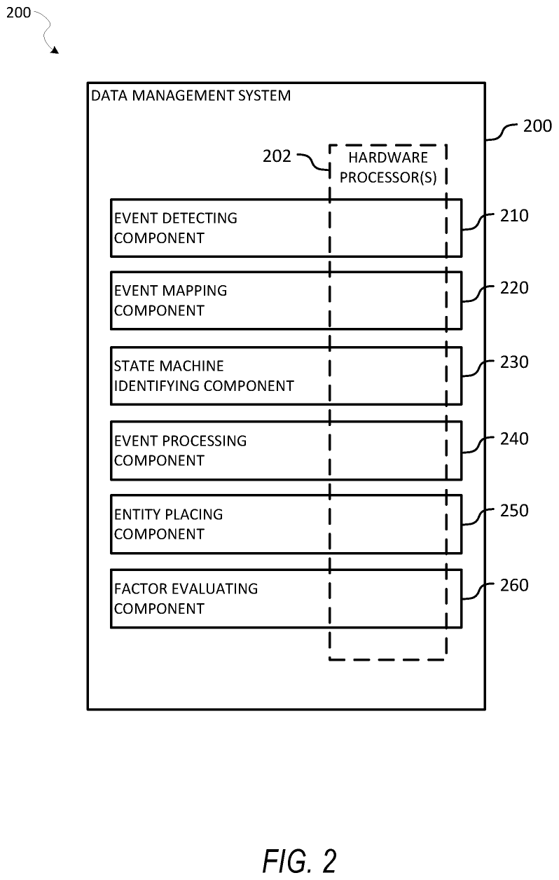

FIG. 2 is a block diagram illustrating an example data management system 200 that facilitates the generation and management of communication workflows using event filters, according to various embodiments of the present disclosure. For some embodiments, the data management system 200 represents an example of the data management system 122 described with respect to FIG. 1. As shown, the data management system 200 comprises an event detecting component 210, an event mapping component 220, a state machine identifying component 230, an event processing component 240, an entity placing component 250, and a factor evaluating component 260. According to various embodiments, one or more of the event detecting component 210, the event mapping component 220, the state machine identifying component 230, the event processing component 240, the entity placing component 250, and the factor evaluating component 260 are implemented by one or more hardware processors 202. Data generated by one or more of the event detecting component 210, the event mapping component 220, the state machine identifying component 230, the event processing component 240, the entity placing component 250, and the factor evaluating component 260 can be stored in a database (not shown) of the data management system 200.

The event detecting component 210 is configured to detect one or more events. Each event can include (or be associated with) a state object that indicates a state of a user and/or a state of an action associated with a user. An event can be a system-generated event or a user-triggered event.

The event mapping component 220 is configured to map one or more events to one or more communication workflows based on the content of the one or more events. A journey can include one or more workflows. The mapping of the one or more events includes determining that the content of the one or more events satisfies the definitions of the journeys.

The state machine identifying component 230 is configured to identify one or more state machines associated with one or more journeys. A state machine can refer to a computational model that represents different states of complex systems and/or communication processes and the transitions between those states based on certain events or conditions.

The event processing component 240 is configured to process one or more events (e.g., filtered events) based on the associated one or more state objects in accordance with one or more steps defined for one or more journeys.

The entity placing component 250 is configured to place an entity (e.g., a user) in a step (e.g., a current step) in the journey. The current step matches the state object of a filtered event.

The factor evaluating component 260 is configured to evaluate one or more factors to determine that an entity is not simultaneously placed in another step of a journey. One or more factors can correspond to one or more of, without limitation, the evaluation of memberships, setting of evaluation windows, setting of priorities, existing entities, moving of profiles, and support analytics.

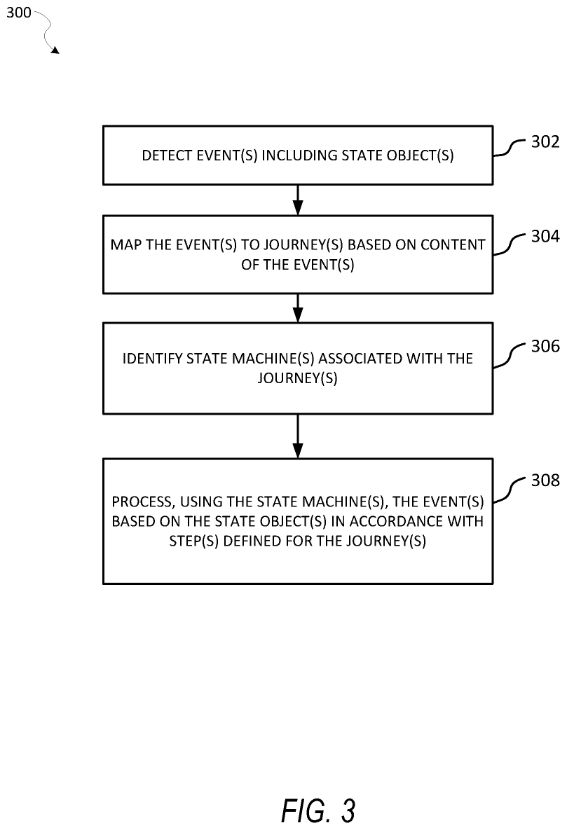

FIG. 3 is a flowchart illustrating an example method 300 for facilitating the generation and management of communication workflows using event filters, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor detects one or more events. Each event can include (or be associated with) a state object that indicates a state of a user and/or a state of an action associated with a user. An event can be a system-generated event or a user-triggered event.

At operation 304, a processor uses one or more event filters to map one or more events to one or more communication workflows (also referred to as journeys) at least based on the content of the one or more events. The mapping of the one or more events includes determining that the content of the one or more events satisfies the definitions of the journeys.

At operation 306, a processor identifies one or more state machines associated with one or more journeys. A state machine can refer to a computational model that represents different states of complex systems and/or communication processes and the transitions between those states based on certain events or conditions. State machines can help manage communication workflows and provide a structured way to design, implement, and manage complex workflows by defining the possible states, the conditions triggering state transitions, and the actions to be taken in each state.

At operation 308, a processor uses one or more state machines to process one or more events (e.g., filtered events) based on the associated one or more state objects in accordance with one or more steps defined for one or more journeys.

Though not illustrated, method 300 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 308 or, alternatively, form part of one or more of operations 302 through 308.

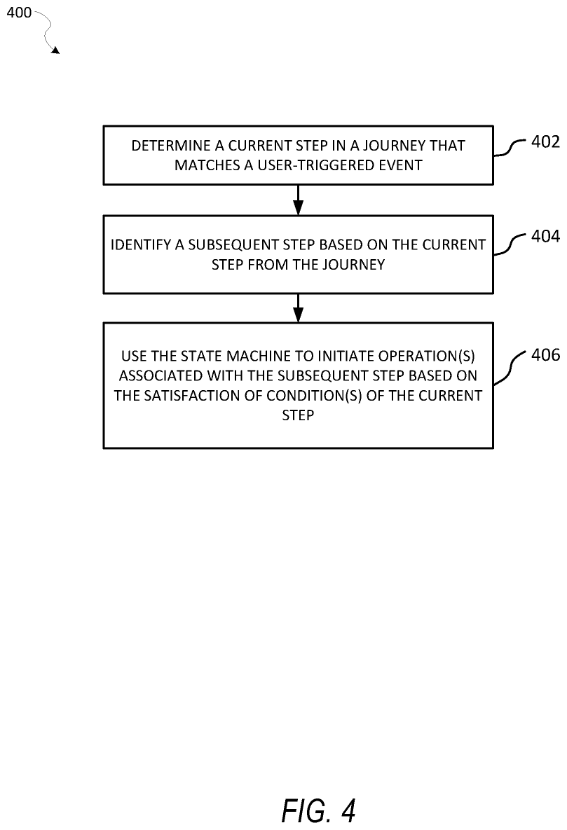

FIG. 4 is a flowchart illustrating an example method 400 for facilitating the generation and management of communication workflows using event filters, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 402, a processor determines a current step in a journey that matches a user-triggered event.

At operation 404, a processor identifies a subsequent step from the journey based on the current step.

At operation 406, a processor uses one or more state machines to initiate one or more operations associated with the subsequent step based on the satisfaction of one or more conditions (and/or triggers) of the current step. The satisfaction of one or more conditions (and/or triggers) of the current step dictates how an entity progresses from the current step to the subsequent step.

In various embodiments, a user can define the conditions and/or events that trigger transitions that cause progression from one state to another handled by a state machine. For example, if a user is transitioned from a “pending” state to a “sending” state, a condition can be the user triggering the sending action. If there are time-dependent transitions (e.g., waiting for a response), timeouts may be configured to handle cases where the expected event fails to occur within a specified timeframe.

In various embodiments, the conditions and/or events can be determined based on the content of filtered events described herein. Filtered events can correspond to actions taken by users (e.g., user-triggered events) or by the system(s) (e.g., system-generated events).

In various embodiments, upon determining, based on the content of the event, that the event does not map to any definition of a journey associated with the entity, the processor generates a state machine based on the event. The generated state machine can model each step in one or more journeys to be configured by the entity and handle transitions from one step to another. The transitions can be handled by initiating one or more operations associated with a subsequent step based on the entity's current state.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

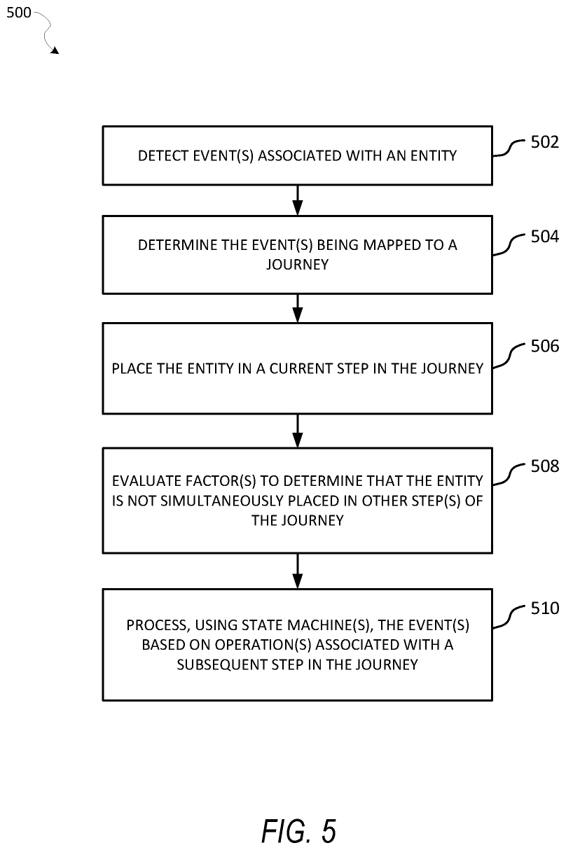

FIG. 5 is a flowchart illustrating an example method 500 for facilitating the generation and management of communication workflows using profile state consistency approach, according to various embodiments of the present disclosure. It will be understood that example methods described herein may be performed by a machine in accordance with some embodiments. For example, method 500 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 502, a processor detects one or more events associated with an entity (e.g., a user). Each event can include (or be associated with) a state object that indicates a state of a user and/or a state of an action associated with a user. An event can be a system-generated event or a user-triggered event.

At operation 504, a processor determines that the one or more events are mapped to one or more journeys. Each journey includes a plurality of steps configured by the entity.

At operation 506, a processor places the entity in a current step in the journey. The placing of the entity can include identifying a current step of the entity by matching the current step to a state object of an event (e.g., a filtered event).

At operation 508, a processor evaluates one or more factors to determine that the entity is not simultaneously placed in another step of the journey. One or more factors can correspond to one or more of, without limitation, the evaluation of memberships, setting of evaluation windows, setting of priorities, existing entities, moving of profiles, and support analytics.

At operation 510, in response to determining that the entity is not simultaneously placed in another step of the journey, a processor identifies a state machine associated with the journey and uses the state machine to process the event based on an operation associated with a step subsequent to the current step in the journey.

At operation 512, a processor updates a profile associated with the entity (e.g., a user) based on the processing of the one or more events.

Though not illustrated, method 500 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 502 through 512 or, alternatively, form part of one or more of operations 502 through 512.

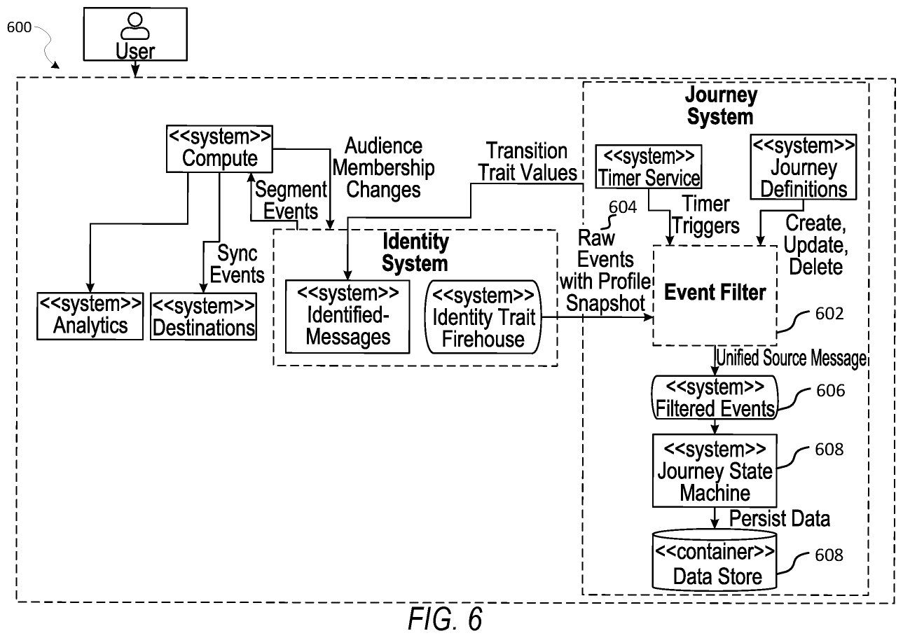

FIG. 6 is a block diagram illustrating an example data system 600 for facilitating the generation and management of communication workflows, according to various embodiments of the present disclosure. Event filter 602 bridges between the journey system and input sources. The journey system can be a subsystem of the data management system described here. Event filter 602 filters incoming messages (e.g., raw events) based on active computations and relays the filtered incoming messages (e.g., filtered events) to the corresponding state machines for processing. The filtered events received from the stream of filtered events 606 can result in one of the following scenarios:

Enter a new journey: If the match (or mapping) is on the entry step for a journey and no epoch is generated, the data management system can create an epoch for the journey based on the event data (e.g., the data content of the event).

Transition to new steps in a journey the user has already entered: If the match (or mapping) is on non-entry steps for a journey, and the epoch for the journey has the matching step as one of the next steps (e.g., subsequent steps), the data management system can apply the event data to the epoch on the journey.

No valid transitions: The event is ignored, discarded, or passed to another system if neither of the above checks succeeds.

Data store 608 can be a low-latency key-value store that stores various data described herein, including event, epoch, and profile data.

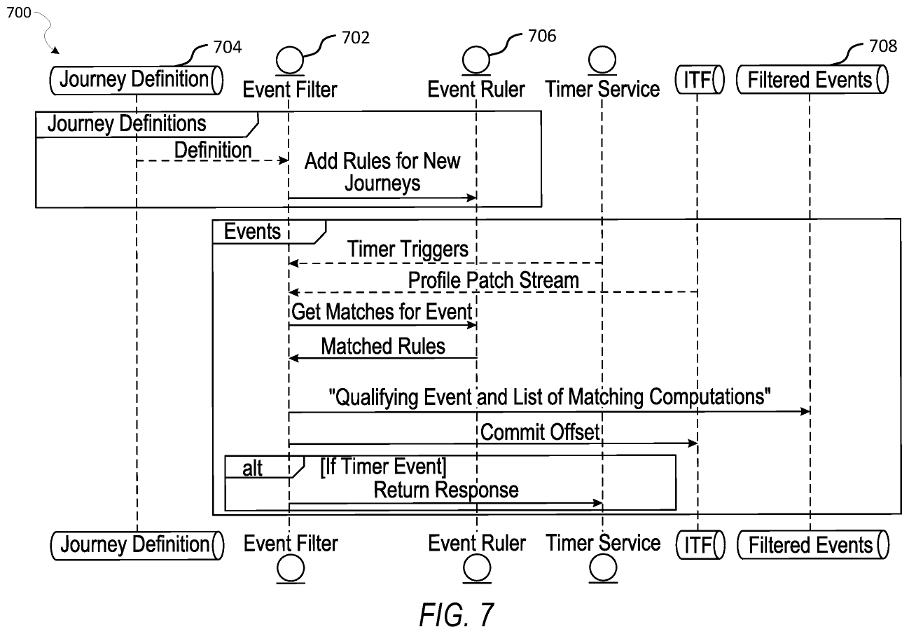

FIG. 7 is a sequence diagram illustrating an example data flow 700 for facilitating the generation and management of communication workflows using an event filter, according to various embodiments of the present disclosure. As shown, event filter 702 filters incoming messages (or raw events) based on journey definition 704 and relays the qualified events (also referred to as filtered events 708) to the corresponding state machines (not shown) for downstream processing.

In various embodiments, in order to map an event to a journey based on the content of the event, the data management system can use a software library (e.g., event ruler 706) to match a plurality of rules against the content of the event. The plurality of rules can be user-defined rules. The event ruler 706 can be a component or an external tool used by the event filter 702 to perform the relevant operations described herein. The event ruler 706 allows users to build applications that match a number of rules against events at a high processing speed. Both events and rules can be JSON objects. Rules can additionally be expressed through an inbuilt query language that describes custom matching patterns.

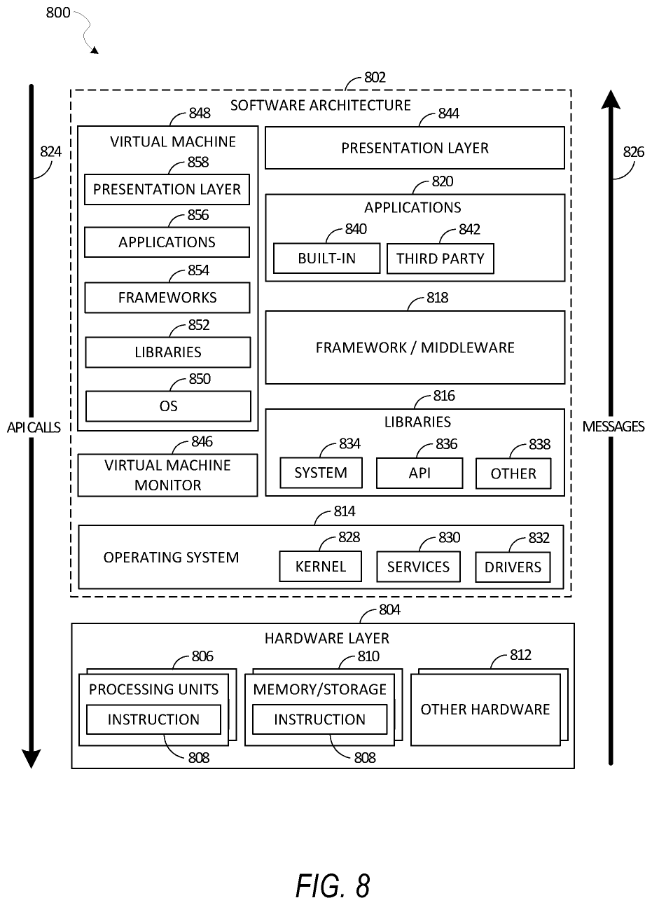

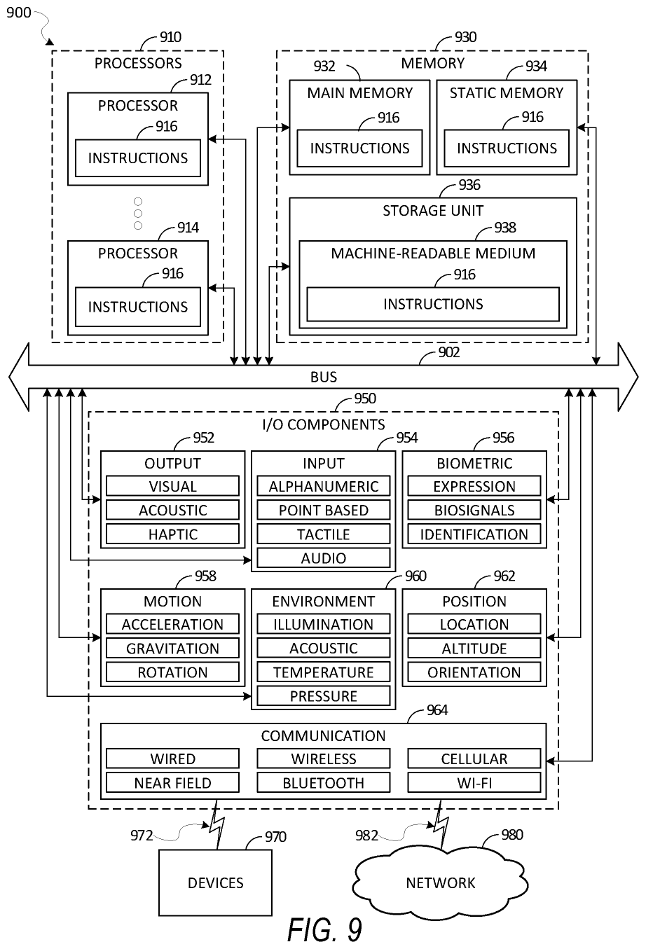

FIG. 8 is a block diagram 800 illustrating an example of a software architecture 802 that may be installed on a machine, according to some example embodiments. FIG. 8 is merely a non-limiting example of a software architecture, and it will be appreciated that many other architectures may be implemented to facilitate the functionality described herein. The software architecture 802 may be executing on hardware such as a machine 900 of FIG. 9 that includes, among other things, processors 910, memory 930, and input/output (I/O) components 950. A representative hardware layer 904 is illustrated and can represent, for example, the machine 900 of FIG. 9. The representative hardware layer 804 comprises one or more processing units 806 having associated executable instructions 808. The executable instructions 808 represent the executable instructions of the software architecture 802. The hardware layer 804 also includes memory or storage modules 810, which also have the executable instructions 808. The hardware layer 804 may also comprise other hardware 812, which represents any other hardware of the hardware layer 804, such as the other hardware illustrated as part of the machine 800.

In the example architecture of FIG. 8, the software architecture 802 may be conceptualized as a stack of layers, where each layer provides particular functionality. For example, the software architecture 802 may include layers such as an operating system 814, libraries 816, frameworks/middleware 818, applications 820, and a presentation layer 844. Operationally, the applications 820 or other components within the layers may invoke API calls 824 through the software stack and receive a response, returned values, and so forth (illustrated as messages 826) in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphical user interface functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a home application, a contacts application, a browser application, a book reader application, a location application, a media application, a messaging application, or a game application.

The third-party applications 842 may include any of the built-in applications 840, as well as a broad assortment of other applications. In a specific example, the third-party applications 842 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 842 may invoke the API calls 824 provided by the mobile operating system such as the operating system 814 to facilitate functionality described herein.

The applications 820 may utilize built-in operating system functions (e.g., kernel 828, services 830, or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with the user.

Some software architectures utilize virtual machines. In the example of FIG. 8, this is illustrated by a virtual machine 848. The virtual machine 848 creates a software environment where applications/modules can execute as if they were executing on a hardware machine (e.g., the machine 800 of FIG. 8). The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, or a presentation layer 858. These layers of software architecture executing within the virtual machine 748 can be the same as corresponding layers previously described or may be different.

FIG. 9 illustrates a diagrammatic representation of a machine 900 in the form of a computer system within which a set of instructions may be executed for causing the machine 900 to perform any one or more of the methodologies discussed herein, according to an embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 300 described above with respect to FIG. 3, the method 400 described above with respect to FIG. 4, and the method 500 described above with respect to FIG. 5. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an embodiment, the processors 910 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936 including machine-readable medium 938, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 950 may include biometric components 956, motion components 958, environmental components 960, or position components 962, among a wide array of other components. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In various embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 900 including processors 910), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 900, but deployed across a number of machines 900. In some example embodiments, the processors 910 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 930, 932, 934, and/or the memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 980 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
detecting an event associated with an entity, the event including a state object;
determining that the event is mapped to a journey that comprises a plurality of steps configured by the entity;
placing the entity in a current step in the journey, the current step matching the state object of the event;
evaluating one or more factors to determine that the entity is not simultaneously placed in another step of the journey; and
in response to the determining that the entity is not simultaneously placed in another step of the journey, using a state machine to process the event based on an operation associated with a step subsequent to the current step in the journey.

2. The method of claim 1, wherein the entity is associated with a profile, comprising:
updating the profile based on the processing of the event.

3. The method of claim 1, the determining that the event is mapped to the journey comprises:
mapping the event to the journey based on content of the event, the mapping of the event including determining that the content of the event satisfies a definition of the journey; and
identifying the state machine associated with the journey.

4. The method of claim 1, wherein the event is a first event, and wherein the entity is a first entity, comprising:
detecting a second event associated with a second entity;
determining that the event does not map to any journey associated with the second entity; and
discarding the event.

5. The method of claim 1, wherein the one or more factors correspond to one or more of evaluation of memberships, setting of evaluation windows, setting of priorities, existing entities, moving of profiles, and support analytics.

6. The method of claim 1, wherein each step in the journey is associated with metadata that is used to reference another step within the journey or a step in another journey.

7. The method of claim 1, comprising:
identifying an attribute of the event; and
storing the attribute of the event in the journey.

8. The method of claim 7, wherein the attribute of the event comprises contextual data that includes one or more of a journey identifier, a step identifier, and timestamp data.

9. The method of claim 1, wherein the journey comprises one or more steps sequentially arranged in a logical order, the journey allowing a user to trigger an operation associated with a step of the journey once an operation associated with a previous step of the journey has been triggered.

10. The method of claim 1, wherein the event corresponds to a system-generated event or a user-triggered event.

11. A system comprising:
one or more hardware processors; and
a non-transitory machine-readable medium for storing instructions that, when executed by the one or more hardware processors, cause the one or more hardware processors to perform operations comprising:
detecting an event associated with an entity, the event including a state object;
determining that the event is mapped to a journey that comprises a plurality of steps configured by the entity;
placing the entity in a current step in the journey, the current step matching the state object of the event;
evaluating one or more factors to determine that the entity is not simultaneously placed in another step of the journey; and
in response to the determining that the entity is not simultaneously placed in another step of the journey, using a state machine to process the event based on an operation associated with a step subsequent to the current step in the journey.

12. The system of claim 11, wherein the entity is associated with a profile, and wherein the operations comprise:
updating the profile based on the processing of the event.

13. The system of claim 11, the determining that the event is mapped to the journey comprises:
mapping the event to the journey based on content of the event, the mapping of the event including determining that the content of the event satisfies a definition of the journey; and
identifying the state machine associated with the journey.

14. The system of claim 11, wherein the event is a first event, wherein the entity is a first entity, and wherein the operations comprise:
detecting a second event associated with a second entity;
determining that the event does not map to any journey associated with the second entity; and
discarding the event.

15. The system of claim 11, wherein the one or more factors correspond to one or more of evaluation of memberships, setting of evaluation windows, setting of priorities, existing entities, moving of profiles, and support analytics.

16. The system of claim 11, wherein each step in the journey is associated with metadata that is used to reference another step within the journey or a step in another journey.

17. The system of claim 11, wherein the operations comprise:
identifying an attribute of the event; and
storing the attribute of the event in the journey.

18. The system of claim 17, wherein the attribute of the event comprises contextual data that includes one or more of a journey identifier, a step identifier, and timestamp data.

19. The system of claim 11, wherein the journey comprises one or more steps sequentially arranged in a logical order, the journey allowing a user to trigger an operation associated with a step of the journey once an operation associated with a previous step of the journey has been triggered.

20. A non-transitory machine-readable medium for storing instructions that, when executed by one or more hardware processors, cause the one or more hardware processors to perform operations comprising:
detecting an event associated with an entity, the event including a state object;
determining that the event is mapped to a journey that comprises a plurality of steps configured by the entity;
placing the entity in a current step in the journey, the current step matching the state object of the event;
evaluating one or more factors to determine that the entity is not simultaneously placed in another step of the journey; and
in response to the determining that the entity is not simultaneously placed in another step of the journey, using a state machine to process the event based on an operation associated with a step subsequent to the current step in the journey.
